(19) United States
(12) Patent Application Publication
(10) Pub. No.: US 2013/0007673 A1
(43) Pub. Date: Jan. 3, 2013

(54) REPOSITION PHYSICAL MEDIA

(76) Inventors: Peter M. On, Houston, TX (US); Dustin L. Hoffman, Cypress, TX (US); Michael Delpier, Houston, TX (US)

(21) Appl. No.: 13/171,261

(22) Filed: Jun. 28, 2011

(51) Int. Cl. G06F 3/033; G06F 3/041

(52) U.S. Cl. 715/863; 345/173

(57) ABSTRACT

A device including a touch component to detect a directional hand gesture, a media compartment to receive physical media, and a mechanism to reposition the physical media from the media compartment if the directional hand gesture is detected and if the media compartment includes the physical media.

### BACKGROUND

If a user would like to eject or remove physical media from a device, the user can manually press a physical button coupled to a media compartment of the device. In response to the physical button being pressed, the device can instruct the media compartment to release a tray and eject the physical media. Through continued use, the physical button may become worn and unresponsive, resulting in difficulties if a user would like to eject or remove the physical media.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with a media compartment and a touch component according to an embodiment.

FIG. 2 illustrates a touch component detecting a directional hand gesture from a user according to an embodiment.

FIG. 3 illustrates a media compartment to receive physical media according to an embodiment.

FIG. 4 illustrates a block diagram of a media application identifying an instruction associated with a detected hand gesture according to an embodiment.

FIG. 5 illustrates a media application on a device and the media application stored on a removable medium being accessed by the device according to an embodiment.

FIG. 6 is a flow chart illustrating a method for managing physical media according to an embodiment.

FIG. 7 is a flow chart illustrating a method for managing physical media according to an embodiment.

### DETAILED DESCRIPTION

A touch component is an input component of the device which can detect a directional hand gesture in response to a user touching or making contact with the touch component. In one embodiment, the touch component can be a touchpad or a touch screen of a device. By detecting the directional hand gesture, the device can identify an instruction associated with information of the directional hand gesture. In response, a mechanism of the device can reposition physical media from a media compartment of the device if any physical media is included within the media compartment. The media compartment can include a slot bay and/or tray of the device configured to receive the physical media. As a result, a user can conveniently access the media compartment and any physical media included in the media compartment using the touch component.

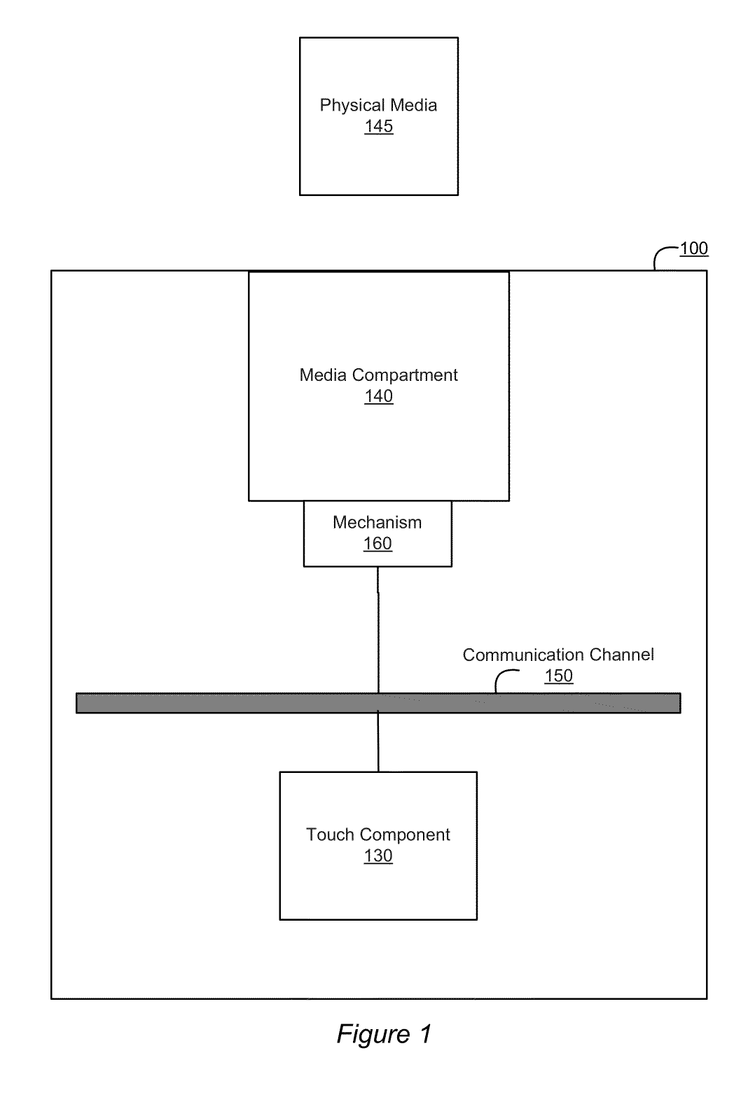

FIG. 1 illustrates a device 100 with a media compartment 140 and a touch component 130 according to an embodiment. In one embodiment, the device 100 can be a laptop, a notebook, a tablet, a netbook, an all-in-one system, desktop, and/or a server. In another embodiment, the device 100 can be a cellular device, a PDA (Personal Digital Assistant), an E (Electronic)—Reader, a tablet, a camera, and/or any additional device which can include a media compartment 140 and a touch component 130.

As illustrated in FIG. 1, the device 100 includes a media compartment 140, a mechanism 160, a touch component 130 and a communication channel 150 for the device 100 and/or one or more components of the device 100 to communicate with one another. In one embodiment, the device 100 includes a controller and/or a media application stored on a computer readable medium included in or accessible to the device 100. In other embodiments, the device 100 includes additional components and/or is coupled to additional components in addition to and/or in lieu of those noted above and illustrated in FIG. 1.

For the purposes of this application, a media compartment 140 is a storage compartment of the device 100 configured to receive physical media 145. The media compartment 140 can interface the physical media 145 with the device 100 so that the controller and/or the media application can access content from the physical media 145 and/or write content to the physical media 145. In one embodiment, the media compartment 140 can be a slot bay configured to receive the physical media 145. In another embodiment, the media compartment 140 can be an extendable and/or retractable tray configured to receive the physical media 145.

The physical media 145 can be a storage device configured to record, store, and/or process content. The content can include media, information, data, and/or files. In one embodiment, the physical media 145 is a CD (compact digital) disc, a DVD (digital versatile disc) disc, a Blu-ray disc drive, a high definition (HD) disc, a mini-disc, a laser disc, and/or any additional optical disc. In another embodiment, the physical media 145 can be a SD (serial digital) card, a compact flash card, a XD (extreme digital) card, and/or any additional device which can be received by the media compartment 140.

In other embodiments, the physical media 145 can operate as a component for the device 100. The physical media 145 can operate as security token for authentication purposes on the device 100. In other embodiments, the physical media 145 can operate as a network interface, a media component, and/or as any additional component for the device 100.

The media compartment 140 can receive the physical media 145 in response to the physical media 145 being inserted into a slot bay of the media compartment 140. In another embodiment, the media compartment 140 can receive the physical media 145 in response to the physical media 145 being placed onto a tray of the media compartment 140 and the tray being inserted into the media compartment 140.

In response to the media compartment 140 receiving the physical media 145, a mechanism of the device 100 can be used to secure the physical media 145 within the media compartment 140. For the purposes of this application, a mechanism 160 can be a hardware component of the device 100 configured to position the physical media 145 in the media compartment 140 and/or reposition the physical media 145 from the media compartment 140.

In one embodiment, the mechanism 160 can include a latch to secure and position the physical media 145 within the media compartment 140. Additionally, the mechanism 160 can reposition the physical media 145 from the media compartment 140 by releasing the latch. In another embodiment, the mechanism 160 can include a motor to receive the physical media 145 and secure the physical media 145 in a position. Additionally, the mechanism 160 can reposition the physical media 145 from the media compartment 140 using the motor. By repositioning the physical media 145 from the media compartment 140 using the mechanism 160, the physical media 145 can be ejected and/or removed from the media compartment 140.

The mechanism 160 can reposition the physical media 145 from the media compartment 140 in response to a touch component 130 of the device 100 detecting a directional hand gesture from a user. For the purposes of this application, a touch component 130 is an input component of the device 100 which can detect a user touching the touch component and register the touch as an input for a device. The touch component 130 can include a touch sensitive pad or surface configured to detect a touch from the user. In one embodiment, the touch component 130 is a touchpad of the device 100. In another embodiment, the touch component 130 is a touch screen of the device 100. The user can touch the touch component 130 with a finger, hand, palm, and/or with any additional part of the user's body. In another embodiment, the user can touch the touch component using an accessory, such as a stylus.

For the purposes of this application, a directional hand gesture can include one or more motions made on the touch component 130 as the user is touching the touch component 130. When detecting a directional hand gesture, the touch component 130 can detect for a hand and/or a finger of the user touching the touch component 130 and repositioning over the touch component 130 while making contact with the touch component 130. The touch component 130 can detect for one or more vertical motions and one or more horizontal motions when detecting for the directional hand gesture.

In one embodiment, the directional hand gesture can include a predefined sequence of vertical motions and/or horizontal motions. The touch component 130 can detect for the predefined sequence of vertical and/or horizontal motions when detecting for the directional hand gesture. In response to detecting the directional hand gesture, the mechanism 160 can reposition the physical media 145 from the media compartment 140.

In another embodiment, the touch component 130 can share touch information of the user touching the touch component 130 with the controller and/or the media application. The controller and/or the media application can determine whether the sequence of vertical motions and/or horizontal motions is associated with an instruction to release the media compartment 140. If the sequence of motions is associated with the instruction, the controller and/or the media application proceed to instruct the mechanism 160 to reposition the physical media 145 from the media compartment 145.

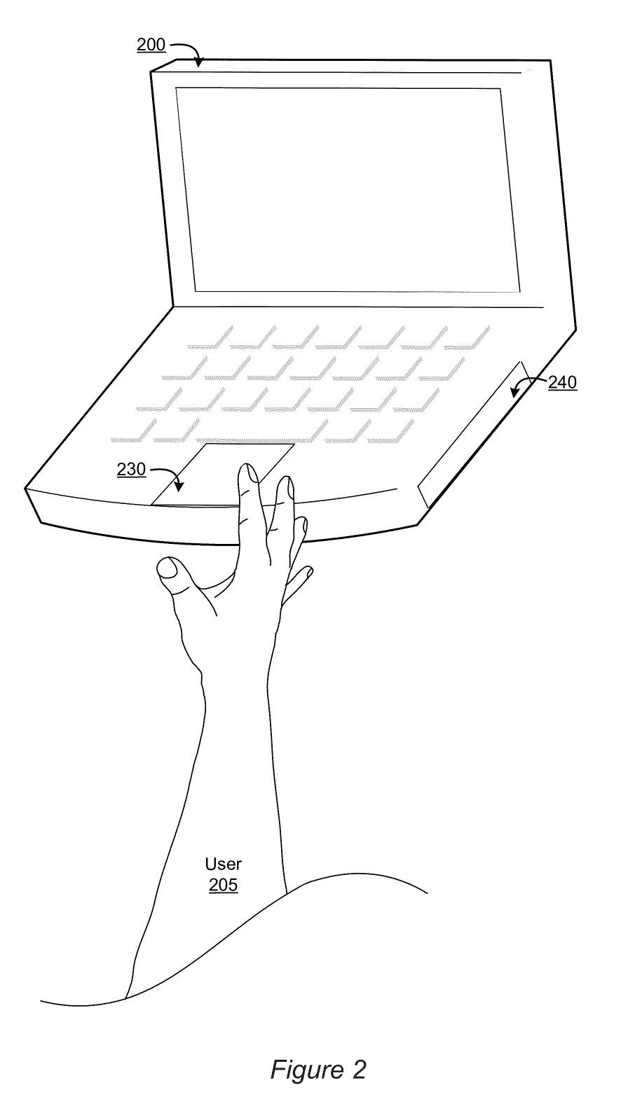

FIG. 2 illustrates a touch component 230 detecting a directional hand gesture from a user 205 according to an embodiment. As illustrated in FIG. 2, the touch component 230 is coupled to the device 200. In one embodiment, the device 200 is a laptop or notebook and the touch component 230 is integrated as part of the device 200. As noted above the touch component 230 is a hardware input component of the device 200 configured to detect a directional hand gesture in response to the user 205 touching the touch component 230.

In one embodiment, the touch component 230 can include a touch sensitive pad or surface, such as a touchpad, configured to detect a directional hand gesture from the user 205. In another embodiment, the touch component 230 can be a touch screen and/or any additional component which can detect a directional hand gesture from a user 205. In one embodiment, the touch component 230 can additionally detect a number of contact points on the touch component 230 when detecting for a directional hand gesture from the user 205.

The user 205 can be any person which can access the touch component 230 of the device 200 to make one or more directional hand gestures. The user 205 can use a finger, hand, palm, and/or any additional part of the user's body to touch the touch component 230 and to make one or more directional hand gestures on the touch component 230. In another embodiment, the user 205 can touch the touch component 230 using an accessory, such as a stylus, to make one or more directional hand gestures.

As noted above, a directional hand gesture includes one or more motions made by the user 205 as the user makes contact with the touch component 230. In one embodiment, a directional hand gesture can include a sequence of vertical motions and/or a sequence of horizontal motions. The user 205 can continuously maintain contact with the touch component 230 when making one or more of the motions on the touch component 230. In response to detecting a directional hand gesture, a mechanism can reposition physical media from a media compartment 240 of the device.

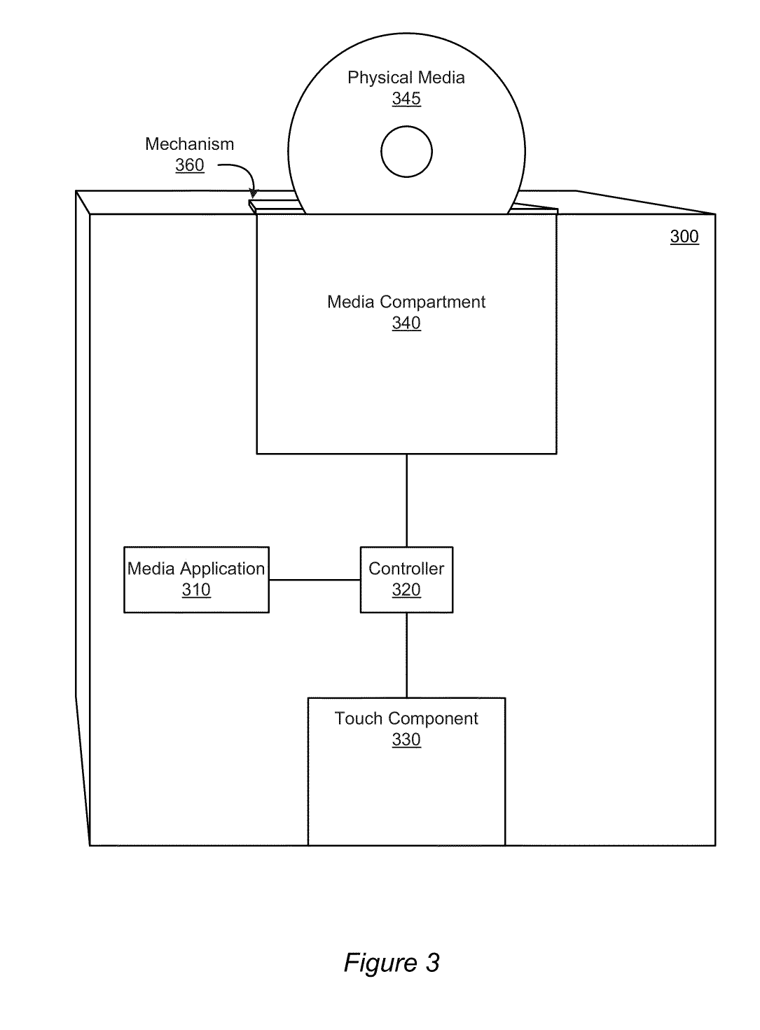

FIG. 3 illustrates a media compartment 340 receiving physical media 345 according to an embodiment. As noted above and as illustrated in FIG. 3, a media compartment 340 is a storage compartment of the device 300 configured to receive physical media 345. In one embodiment, the media compartment 340 can be a SD (serial digital) slot, a compact flash slot, a XD (extreme digital) slot, and/or an optical disc drive. The optical disc drive can be a CD (compact digital) disc drive, a DVD (digital versatile disc) disc drive, a Blu-ray disc drive, and/or a laser disc drive. In other embodiments, the media compartment 340 can include any additional storage bay or compartment configured to receive physical media 345.

The media compartment 340 can include a slot bay configured to receive the physical media 345. The slot bay can be an aperture of the media compartment 340 which the physical media 345 can be inserted into. In another embodiment, the media compartment 340 can include a tray configured to receive the physical media 345. The tray can be a media tray which can hold the physical media 345 as the tray is inserted into the media compartment 340. In one embodiment, the media compartment 340 can additionally include one or more rails and/or any additional component for the tray to be positioned or repositioned.

Additionally, a mechanism 360 of the device 300 can be utilized in conjunction with the media compartment 340 to receive the physical media 345. As noted above, the mechanism 360 is a hardware component of the device 300 configured to position the physical media 345 in the media compartment 340 and/or reposition the physical media 345 from the media compartment 340. In one embodiment, the mechanism 360 can be coupled to the device 300. In another embodiment, the mechanism 360 can be coupled to and/or integrated as part of the media compartment 340.

If the media compartment 340 includes a slot bay, the mechanism 360 can include one or more motors. A motor of the mechanism 360 can rotate in one or more directions. In another embodiment, a motor of the mechanism 360 can extend and/or retract in one or more directions. One or more motors of the mechanism 360 can receive the physical media 345 and rotate or retract to a position such that the physical media 345 is secured within the media compartment 340.

In another embodiment, if the media compartment 340 includes a tray to receive the physical media 345, the media compartment 340 can additionally include a spring to extend the tray from the media compartment 340. Further, the mechanism 360 can include a latch to secure the tray within the media compartment 340. The latch can engage one or more apertures and/or indentions of the media compartment 340, the tray, and/or the device 300 in response to the tray being inserted within the media compartment 340. As a result, the tray remains secured in a position within the media compartment 340 and the spring is retracted and/or compressed.

Once the physical media 345 has been received by the media compartment 340, the controller 320 and/or the media application 310 can access contents of the physical media 345. In one embodiment, the media compartment 340 can include an interface component for a controller 320 and/or a media application 310 of the device 300 to interface with the physical media 345. The controller 320 and/or the media application 310 can identify the physical media 345 as a storage device of the device 300. Additionally, the controller 320 and/or the media application 310 can read and/or write to the physical media 345. Additionally, as noted above, the mechanism 360 can reposition the physical media 345 from the media compartment 340 if the touch component 330 detects a directional hand gesture from a user.

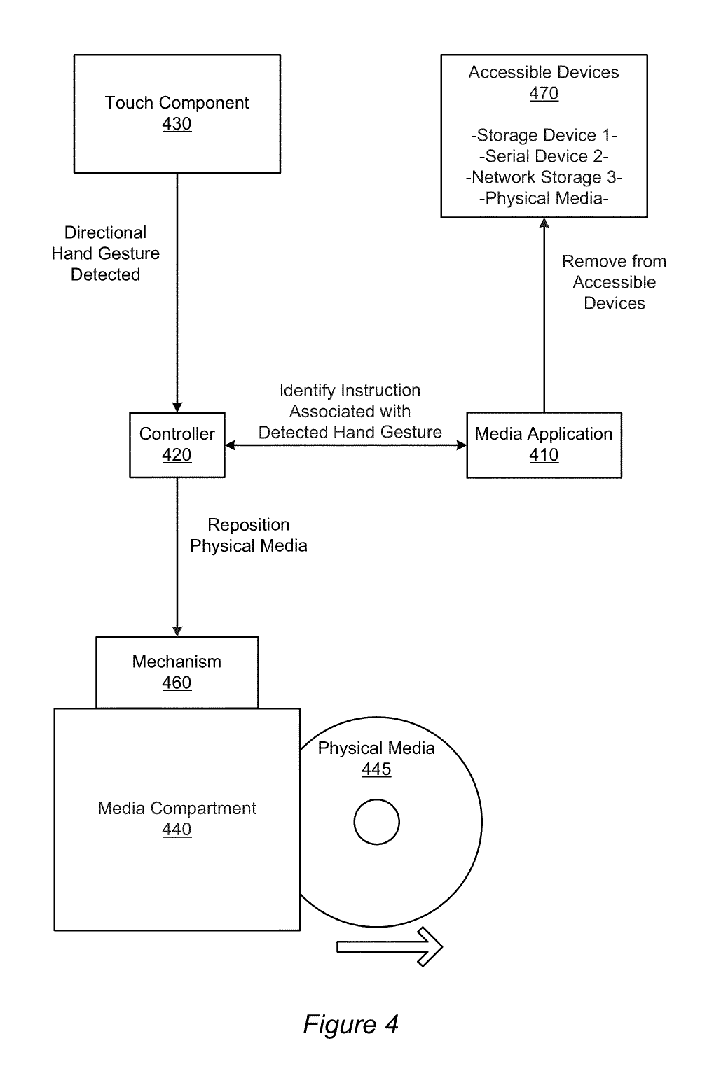

FIG. 4 illustrates a block diagram of a media application 410 identifying an instruction associated with a detected hand gesture according to an embodiment. As noted above, the touch component 430 can detect for one or more touches or contact from a user when detecting for a directional hand gesture. Additionally, the touch component 430 can send the controller 420 and/or the media application 410 information of the touch and/or contact from the user. As shown in the present embodiment, the touch component 430 has detected a user making a directional hand gesture on the touch component 430.

The information of the touch and contact is shared for the controller 420 and/or the media application 410 to identify an instruction associated with the detected hand gesture. In one embodiment, the detected information can specify a number of contact points on the touch component 430. The number of contact points on the touch component 430 corresponds to how many different locations of the touch component 430 are simultaneously being touched by the user. In another embodiment, the detected information can specify a direction of one or more motions made by the user. As noted above, one or more motions can include a vertical motion and/or a horizontal motion. In another embodiment, information from the touch component 430 can further be used by the controller 420 and/or the media application to determine whether the direction of the motion is Up, Down, Left, and/or Right.

The controller 420 and/or the media application 410 can compare the detected information to criteria associated with an instruction for the device. The criteria can be a set of rules specifying a number of contact points, a predefined sequence of motions, and/or a duration of continuing to contact the touch component 430. One or more criteria can be associated with an instruction of the device. Additionally, one or more criteria can be stored as a file, a database, a list, and/or a look-up table.

In one embodiment, a criteria for the directional hand gesture can specify for the there to be at least three contact points on the touch component 430. Additionally, the criteria can specify for a user to initially make a vertical motion while continuing to touch the touch component 430 and then make a subsequent horizontal motion while continuing to touch the touch component 430. In other embodiments, one or more criteria can include additional rules or conditions in addition to and/or in lieu of those noted above.

If the detected information from the touch component 430 matches the criteria, the controller 420 and/or the media application 410 can determine that the directional hand gesture is associated with an instruction. The controller 420 and/or the media application 410 proceed to identify the instruction associated with the detected hand gesture. In one embodiment, the instruction can be a remove or release media compartment instruction for the device. In response to identifying the instruction to be a release media compartment instruction, the controller 420 and/or the media application 410 send an instruction for the mechanism 460 to reposition the physical media 445 from the media compartment 440.

In one embodiment, if the mechanism 460 includes one or more motors. The mechanism 460 can configure one or more motors to rotate and/or extend to reposition the physical media 445 from the media compartment 440. In another embodiment, if the mechanism 460 includes a latch, the mechanism 460 can release the latch. In response, a spring within the media compartment 460 can extend for the physical media 445 to be repositioned from the media compartment 440. By repositioning the physical media 445 from the media compartment 440, the mechanism 460 can eject and/or remove the physical media 445 from the media compartment 440.

In one embodiment, the controller 420 and/or the media application 410 can determine that the physical media 445 is no longer coupled to the device. In response, the controller 420 and/or the media application proceed to remove the physical media 445 from a list of accessible storage devices 470 coupled to the device, indicating that the content of the physical media 445 is no longer accessible on the device.

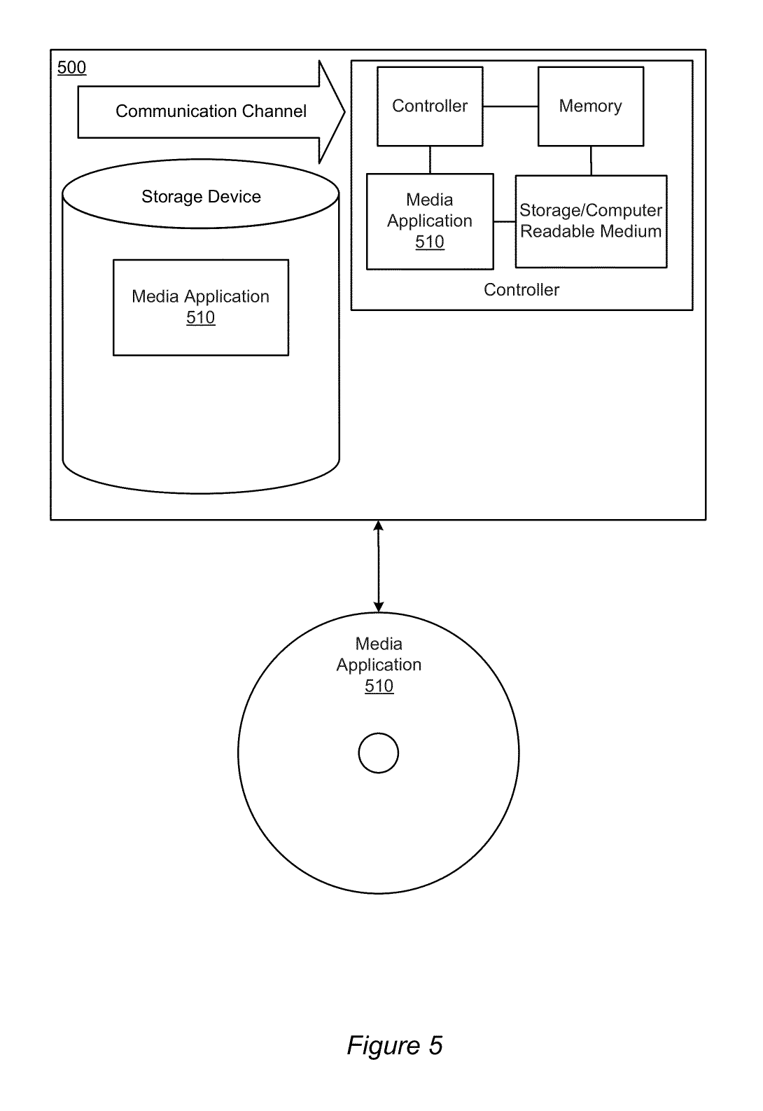

FIG. 5 illustrates a media application 510 on a device 500 and the media application 510 stored on a removable medium being accessed by the device 500 according to an embodiment. For the purposes of this description, a removable medium is any tangible apparatus that contains, stores, communicates, or transports the application for use by or in connection with the device 500. In one embodiment, the media application 510 is firmware that is embedded into one or more components of the device 500 as ROM. In other embodiments, the media application 510 is an application which is stored and accessed from a hard drive, a compact disc, a flash disk, a network drive or any other form of computer readable medium that is coupled to the device 500.

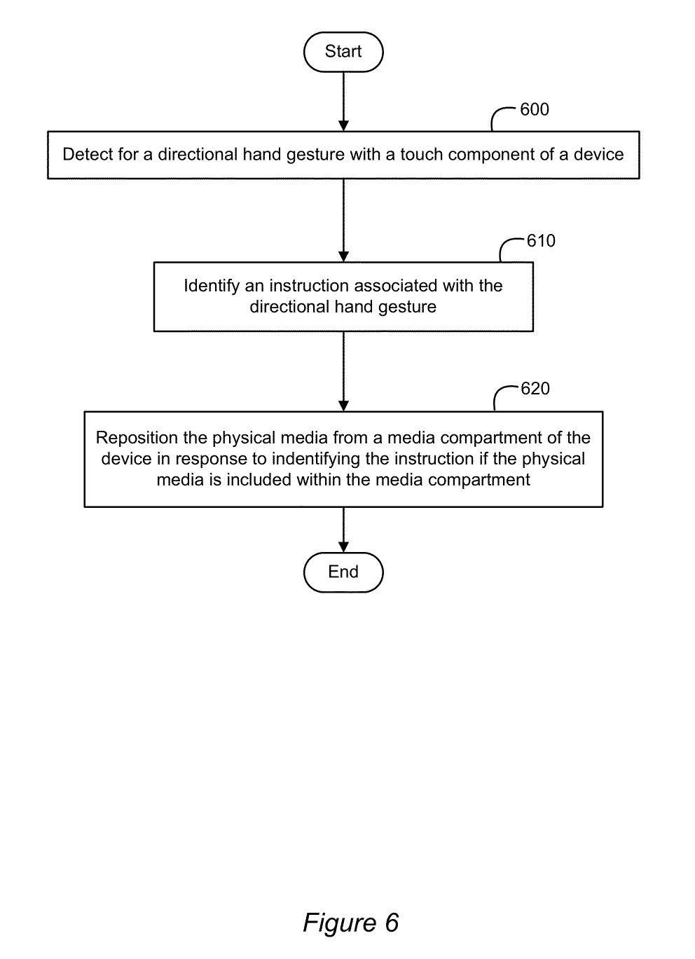

FIG. 6 is a flow chart illustrating a method for managing physical media according to an embodiment. The method of FIG. 6 uses a device with a touch component to detect a directional hand gesture from a user, a media compartment to receive physical media, and a mechanism to reposition the physical media from the media compartment. In another embodiment, the device additionally uses a controller and/or a media application. In other embodiments, the method of FIG. 6 uses additional components and/or devices in addition to and/or in lieu of those noted above and illustrated in FIGS. 1, 2, 3, 4, and 5.

As noted above, the touch component is an input device configure to detect a directional hand gesture from a user in response to detecting the user contacting and/or touching the touch component through a finger, hand, palm, and/or pointing device at 600. The touch component can include a touch sensitive sensor and/or a touch screen. The directional hand gesture includes the user making one or more vertical and/or horizontal motions while maintaining contact with the touch component.

The information of the touch and/or contact from the touch component can be shared with the controller and/or the media application. The controller and/or the media application can then identify an instruction of the device associated with the directional hand gesture at 610. In one embodiment, the controller and/or the media application can compare the detected information from the touch component to criteria of one or more instructions of the device. The criteria can specify a number of contact points for the touch component, a direction of one or more motions, a duration of continuous touch for the touch component, and/or any additional information associated with the an instruction.

If the detected information matches the criteria for the instruction, the controller and/or the media application can determine that the detected hand gesture is associated with the corresponding instruction. In one embodiment, the controller and/or the media application determine that the corresponding instruction is a release media compartment instruction for the device. In response, the controller and/or the media application send an instruction for a mechanism to reposition the physical media from the media compartment if the physical media is included in the media compartment at 620.

As noted above, the mechanism can include a motor to rotate, extend and/or retract to reposition the physical media from the media compartment. In another embodiment, the mechanism can include a latch used to secure the physical media within the media compartment. The latch can release and the physical media can be repositioned from the media compartment. The method is then complete. In other embodiments, the method of FIG. 6 includes additional steps in addition to and/or in lieu of those depicted in FIG. 6.

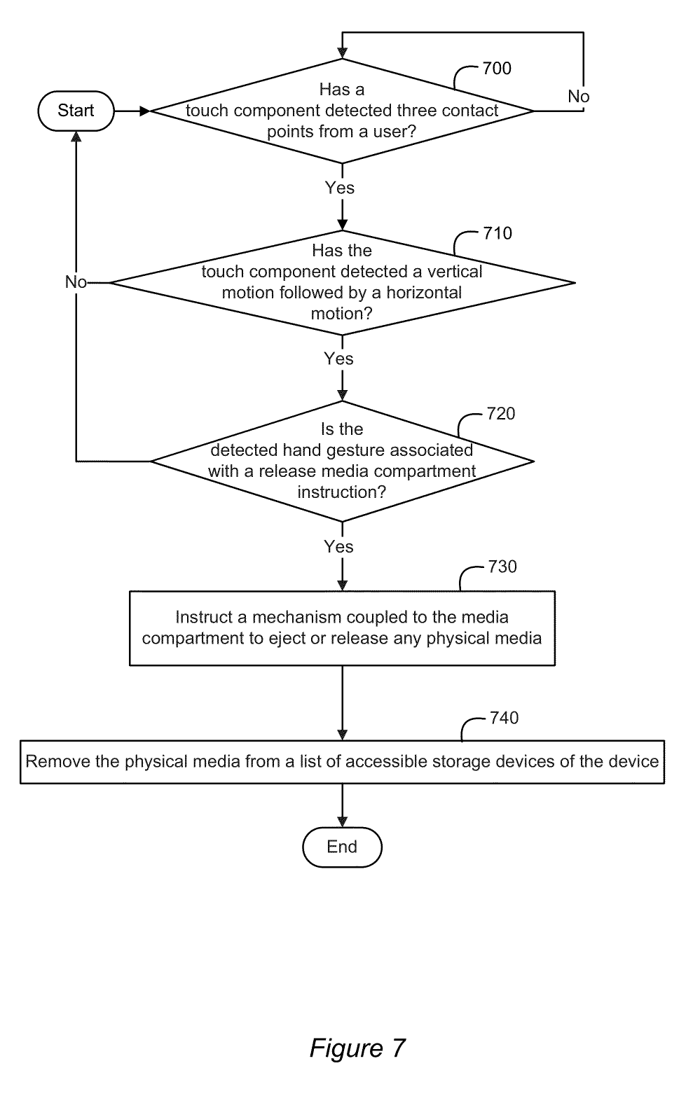

FIG. 7 is a flow chart illustrating a method for managing physical media according to another embodiment. Similar to the method disclosed above, the method of FIG. 7 uses a device with a touch component to detect a directional hand gesture from a user, a media compartment to receive physical media, and a mechanism to reposition the physical media from the media compartment. In another embodiment, the device additionally uses a controller and/or a media application. In other embodiments, the method of FIG. 7 uses additional components and/or devices in addition to and/or in lieu of those noted above and illustrated in FIGS. 1, 2, 3, 4, and 5.

As noted above, a touch component can initially detect touch and/or contact information in response to a user accessing the touch component. The touch and/or contact information can specify a number of contact points on the touch component, a direction of one or more motions made on the touch component, a duration of contact on the touch component, and/or any additional information. Additionally, the controller and/or the media application can determine whether the detected information matches criteria associated with an instruction of the device.

The controller and/or the media application can determine whether the detected information includes three contact points from the user at 700. If three contact points are not identified by the controller and/or the media application, the controller and/or the media application continue to detect for three or more contact points. If three contact points have been detected, the controller and/or the media application proceed to determine whether the detected information indicates that the user has made a vertical motion followed by a horizontal motion at 710. If a vertical motion followed by a horizontal motion has not been detected, the controller and/or the media application return to determine whether three contact points are detected at 700.

In another embodiment, if vertical motion has been detected followed by a horizontal motion, the controller and/or the media application attempt to identify an in instruction, such as a release media compartment instruction, for the device associated with the directional hand gesture at 720. As noted above, the controller and/or the media application can access a file, a list, a database, and/or a lookup table to determine whether the detected information of the directional hand gesture matches criteria associated with an instruction. If the directional hand gesture does not match any criteria, no instruction matches the directional hand gesture and the controller and/or the media application continue to detect for three contact points on the touch component at 700.

In another embodiment, if the information of the directional hand gesture matches criteria associated with a release media compartment instruction, the controller and/or the media application instruct a mechanism of the device to reposition the physical media from the media compartment at 730. As noted above, the media compartment can is a storage compartment of the device which can include a slot bay and/or tray of the device configured to receive the physical media.

The mechanism is a component coupled to the device and/or the media compartment. The mechanism can position and/or reposition the physical media using a latch and/or motor of the mechanism. If the mechanism includes a motor and the media compartment is a slot bay, the motor can rotate, extend, and/or retract to reposition the physical media from the media compartment. In another embodiment, if the mechanism includes a latch and the media compartment includes a tray, the mechanism can release the latch such that a spring can extend and reposition the tray and the physical media from the media compartment.

In response to the physical medial being removed or ejected from the media compartment, the controller and/or the media application can remove the physical media from a list of accessible storage devices on the device at 740. As a result, contents of the physical media are no longer accessible to the controller and/or the media application. The method is then complete. In other embodiments, the method of FIG. 7 includes additional steps in addition to and/or in lieu of those depicted in FIG. 7.

What is claimed is:

1. A device comprising:
a touch component to detect a directional hand gesture;
an media compartment to receive physical media; and
a mechanism to reposition the physical media from the media compartment in response to the touch component detecting the directional hand gesture if the media compartment includes the physical media.

2. The device of claim 1 wherein the touch component detects for at least one of a pointing device and a hand of a user if detecting for the directional hand gesture.

3. The device of claim 2 wherein the directional hand gesture includes a vertical motion and a horizontal motion.

4. The device of claim 1 wherein the mechanism is coupled to the media compartment.

5. The device of claim 4 wherein the mechanism includes a latch to secure the physical media in the media compartment in response to the media compartment receiving the physical media.

6. The device of claim 5 wherein the controller instructs the mechanism to release the latch for the physical media to be ejected from the media compartment.

7. The device of claim 1 wherein the mechanism includes a motor to receive the physical media and eject the physical media from the media compartment.

8. A method for managing physical media comprising:
detecting a directional hand gesture with a touch component of a device;
identifying an instruction associated with the directional hand gesture; and
repositioning physical media from a media compartment of the device in response to indentifying the instruction and if the physical media is included within the media compartment.

9. The method for managing physical media of claim 8 wherein repositioning the physical media includes ejecting the physical media from the media compartment.

10. The method for managing physical media of claim 8 wherein detecting for the direction hand gesture includes the touch component detecting for at least three contact points from at least one of a hand of a user and a pointing device of the user.

11. The method for managing physical media of claim 8 wherein identifying the directional hand gesture includes the touchpad initially detecting for a vertical motion and then detecting for a horizontal motion.

12. The method for managing physical media of claim 8 further comprising determining if the directional hand gesture is associated with a release media compartment instruction of the device.

13. The method for managing physical media of claim 8 further comprising removing the physical media from a list of accessible storage devices of the device.

14. A computer readable medium comprising instructions that if executed cause a controller to;
detect a directional hand gesture from a touch component and identify an instruction associated with the directional hand gesture; and
reposition physical media from a media compartment of the device with a mechanism if the directional hand gesture is a release media compartment instruction and if the media compartment includes the physical media.

15. The computer readable medium comprising instructions of claim 14 wherein the media compartment includes at least one of a SD (serial digital) slot, a compact flash slot, a XD (extreme digital) slot, and an optical disc drive.

16. The computer readable medium comprising instructions of claim 15 wherein the optical disc drive includes receives at least one of a CD (compact digital) disc, a DVD (digital versatile disc) disc, a Blu-ray disc, and a laser disc.

17. The computer readable medium comprising instructions of claim 14 wherein the physical media operates as a component of the device if the physical media is included within the media compartment.

18. The computer readable medium comprising instructions of claim 14 wherein the touch component is a touchpad of the device.

19. The computer readable medium comprising instructions of claim 14 wherein the touch component is a touch screen of the device.

20. The computer readable medium comprising instructions of claim 14 repositioning the physical media includes the controller sending an instruction to the mechanism to eject the physical media from the media compartment.
